(19) United States
(12) Patent Application Publication
(10) Pub. No.: US 2004/0114497 A1
(43) Pub. Date: Jun. 17, 2004

(54) Spindle motor for driving optical disk

(75) Inventors: Chil Sung Lee, Suwon-Shi (KR); Tae Heon Kim, Yongin-Shi (KR)

Correspondence Address: DARBY & DARBY P.C., P. O. BOX 5257, NEW YORK, NY, 10150-5257, US

(73) Assignee: Samsung Electro-Mechanics Co., Ltd., Suwon-Shi (KR)

(21) Appl. No.: 10/412,436

(22) Filed: Apr. 11, 2003

(30) Foreign Application Priority Data
Dec. 12, 2002 (KR) 2002-79067

(51) Int. Cl. G11B 23/00; G11B 25/00

(52) U.S. Cl. 369/266

(57) ABSTRACT

Disclosed is a spindle motor adopted to a disk player. The spindle motor includes: a deck plate; a pivot mounted on the deck plate, for being rotatable; a rotor of a cap shape, joined to an outer peripheral surface of an upper side of the pivot and having tracks formed in different heights on an upper portion, and on an inner peripheral surface of which a magnet is mounted; a pulling magnet provided to a lower portion of the rotor, for generating attractive force pulling the rotor to the lower portion; a stator including a metal bearing positioned on a lower portion of the rotor and mounted on an outer peripheral surface of the pivot, a holder provided to an outer peripheral surface of the metal bearing, and a core wired by a coil provided to an outer peripheral surface of the holder; and a turntable including a disk chuck fixed on an upper surface of the rotor, for centering and settling a disk, and a jaw installed on the disk chuck, for fixing a settled disk.

The pulling magnet is mounted downward on the housing in the upper end of the stator in a subsiding manner, so that the whole height of the spindle motor could be reduced as much as the downward depth of the pulling magnet. Also, the turntable is mounted downward on the track of the rotor in a subsiding manner, so that the whole height of the spindle motor is reduced ever more.

### BACKGROUND OF THE INVENTION

1. Field of the Invention

The present invention relates to a small sized spindle motor adopted to a disk player and more particularly to a spindle motor having more compact structure by reducing height of a motor.

2. Description of the Related Art

In general, an optical disk is capable of performing recording and playing relatively in high density compared to a magnetic recording tape and a LP (Long Playing Record), and has a strong point that semipermanent keeping is possible, so that recently a disk player using this optical disk is being popularized.

For such disk player, there exist a laser disk player, a compact disk player, and a DVD (Digital Versatile Disc) player. Among such optical disk players, particularly a small sized and potable compact disk player is now universally used, but recently the DVD player using the DVD, which is large in its recoding capacity but is the same in its size compared to the compact disc, is rapidly being popularized.

Such disk player is getting minimized in its size, height and weight so that a user may carry conveniently, and in the future, it is expected that a slim type disk player whose height is 9.5 mm, would be mainstream.

One of most important elements in such disk player is a spindle motor for driving a disk, for rotating disk in high speed without vibration, and the spindle motor is also getting small sized to meet the height of the disk player that is being small sized.

Of course, the small sized motor, in spite of its small size, should show high speed performance using minimum current, and prevent detachment of a disk upon driving in high speed, as well as minimizing vibration generated upon driving.

FIG. 1 is a sided, cross-sectional view of a structure of the general spindle motor for driving a disk. As shown in FIG. 1, the general spindle motor consists of a deck plate 1, on the upper side of which a printed circuit board is mounted, for being fixed on a disk player not shown, and a pivot 10 vertically mounted on the deck plate 1, for being rotatable.

At the moment, a thrust bearing 11 for preventing the pivot from being rubbed against the deck plate is mounted on the lower end of the pivot 10, and a stopper ring 12 for preventing the pivot 10 from rising to the above due to centrifugal force generated upon rotation in high speed, is provided to the lower side of the pivot 10.

The general spindle motor additionally includes: a metal bearing 22 of a cylindrical shape, mounted on the outer peripheral surface of the pivot 10, for supporting the pivot so that the pivot is vertically erected; a holder 24 of a cylindrical shape mounted on the outer peripheral surface of the metal bearing 22; and a stator consisting of a core 28 wired by coils 26 for generating magnetic force by power source applied.

In the meantime, a coating layer 28a for protecting the coil 26 and the core 28 is formed on the upper side of the core 28. For material for such coating layer 28a, epoxy is most generally used.

In addition, the general spindle motor also includes a metal rotor 40 of a cap shape joined to the upper end of the pivot 10, for being positioned on the upper portion of the stator 20, and the pivot 10 is pushed and fixed on the inner peripheral surface of the cylindrical shaped boss 42 projected from the central portion of the rotor 40, so that the rotor 40 and the pivot 10 are integrally joined as one body.

In addition, the general spindle motor also includes: a magnet 45 mounted on the inner peripheral surface of the rotor, for facing the core 28 of the stator 20 with an air gap intervened, a pulling magnet 30 attached on the upper side of the core 28 of the stator 20, for pulling the rotor 40 by magnetic force generated.

Of course, the pulling magnet 30 should maintain a gap (g) with respect to the lower side of the rotor in order to prevent frictional interference with the rotor 40.

In the meantime, a turntable 50 fixed integrally with the rotor 40, for settling down a disk (D) is mounted on the upper side of the rotor 40, and the turntable 50 consists of: a disk chuck 52 for centering a disk (D) so that a disk (D) is settled down on the exact position in the turntable 50; a jaw 54 for moving a disk (D) on the disk chuck 52 in a sliding manner, and fixing a disk (D) settled on the disk chuck 52; and a disk sheet 56 for supporting the settled disk (D) at the lower side.

At the moment, the jaw 54 is inserted into the interior of the lateral side of the disk chuck 52 together with a spring 54a, and the disk sheet 56 is formed in a flange shape extended from the lower portion of the disk chuck 52, forming one body together with the disk chuck 52.

Here, procedure that the turntable 50 and the rotor 40 are integrally fixed, will be described more specifically. The disk chuck 52 has a hub 52a having a cavity in its center, and the hub 52a of the disk chuck 52 is positioned to the boss 42 of the rotor 40, then the disk chuck 52 is pushed down from the upper side so that the boss 42 is pushed and fixed on the inner peripheral surface of the hub 52a.

Of course, in order for the boss 42 of the rotor 40 to be pushed and fixed on the hub 52a of the disk chuck 52, the inner diameter of the hub 52a should be precisely processed to be the same as the outer diameter of the boss 42, and thanks to the same inner and outer diameters of the hub 52a and the boss 42, the disk chuck 52 is forcibly fit in the rotor 40.

At the moment, in order for the forcibly fit disk chuck 52 to be more strongly fixed in the rotor, the disk chuck 52 is forcibly fit after an adhesive (B) is plastered on the outer peripheral surface of the boss 42 of the rotor 40.

The general spindle motor for driving a disk having the foregoing construction, is operated as follows, in which: the disk chuck 52 of the turntable 50 performs centering for a through hole formed on the center of a disk (D), fixing the same, and the jaw 54 is slid into the interior of the lateral side of the disk chuck 52 by means of the through hole formed on a disk (D) upon fixing, and then when centering is completed, the jaw 54 is again projected, in a sliding manner, into the exterior of the disk chuck 52 by elastic force of the spring 54a, fixing a disk (D) by pushing and pressing the inside of the through hole of a disk (D).

If fixing of a disk (D) is completed, power source is applied to the coil 26 of the stator 20, so that magnetic force is generated to the core 28, whereby magnetic force of the core 28 and magnetic force of the magnet 45 interact each other.

Then, the core 28 and the magnet 45 rotate the pivot 10 together with the rotor 4 by interaction of magnetic forces generated.

At the moment, the pivot 10 could smoothly rotate in high speed at vertical status without vibration thanks to the metal bearing 22 mounted on the outer peripheral surface, and does not rise to the above upon high speed rotation thanks to the stopper ring 12 mounted on the lower end of the pivot 10.

Namely, the metal bearing 22 supports the pivot 10 rotating in high speed at the outer peripheral surface, and the stopper ring 12 prevents the pivot 10 from rising to the above due to centrifugal force generated upon high speed rotation.

In the meantime, the rotor 40 rotating in high speed together with the pivot 10 also would rise due to centrifugal force generated upon high speed rotation, but rising of the rotor 40 is prevented by attractive force from the pulling magnet 30.

Additionally, due to rotation of the rotor 40, the turntable 50 mounted on the upper side of the rotor 40 is rotated, and a disk (D) settled on the turntable 50 is also rotated in high speed together with the turntable 50, so that the disk player not shown could record data on a disk (D) or play recorded data from a disk (D) in a short period of time.

Of course, a disk (D) does not rise or is not detached from the turntable 50 even though rotated in high speed as the jaw 54 of the turntable 50 strongly fixes a disk (D), and further, a disk (D) does not rise or is not detached thanks to a disk clamp not shown, for pushing a disk (D) at the upper side.

The general spindle motor for driving a disk as described above, however, has a problem that the pulling magnet is floated when the coating layer 28a gets old, for the pulling magnet 30 is mounted on the coating layer 28a of the core 28.

Also, as the pulling magnet 30 is positioned on the upper side of the core 28, forming a shape projected to the upper portion of the stator 20, the height of the stator 20 gets higher and, in case that the coating layer 28a is formed on the surface of the core 28, the height of the stator 20 gets more higher as much as the height of the coating layer 28a.

Of course, in order to minimize the height of the stator 20, the portion of the coating layer 28a on which the pulling magnet 30 is mounted, is chopped off, but even though the coating layer 28a is chopped off, the height of the stator 20 is not reduced very mach, and it is very complicated to chop off the coating layer 28a. Furthermore, it is very difficult to chop off the hardened coating layer 28a.

Also, there exists a problem that the vertical length of the holder 24 should be extended as much as the height of the projected pulling magnet 30, for an appropriate area for receiving the pulling magnet 30 should be prepared on the upper side of the core 28 and the outer peripheral surface of the holder 24 in order to stably support the projected pulling magnet 30.

In addition, as the gap (g) should be formed below the lower side of the rotor 40 at the status that the height of the stator 20 gets high due to extension in the vertical lengths of the pulling magnet 30 and the holder 24, there exists a problem that the whole height (H1) of the spindle motor gets high.

Also, when the hub 52a of the disk chuck 52 is fit in the boss 42 of the rotor 40, the adhesive (B) plastered on the boss 42 is all pushed to the lower side of the boss 42 and gathered at one place on the upper side of the rotor 40, and due to the gathered adhesive (B), the turntable 50 is attached with being floated as much as the thickness of the adhesive (B), so that the whole height (H1) of the spindle motor gets higher.

Finally, due to the adhesive (B) gathered at one place, bonding area of the disk chuck 52 is reduced and adhesive force gets weak, so that the turntable 50 may be detached from the rotor 40 upon high speed rotation.

### SUMMARY OF THE INVENTION

To solve the above-indicated problems, it is, therefore, an object of the present invention to provide a spindle motor for driving a disk, capable of minimizing the whole height of the spindle motor while maintaining performances of the rotor and the pulling magnet by forming a track of stepped structure on the rotor, and forming a housing inward processed on the upper end of the stator so that the turntable and the pulling magnet are mounted on the rotor and the stator in a subsiding manner.

The foregoing and other objects and advantages are realized by providing a spindle motor used in a disk player, the spindle motor for driving a disk according to the present invention, including: a deck plate; a pivot mounted on the deck plate, for being rotatable; a rotor of a cap shape, joined to an outer peripheral surface of an upper side of the pivot and on an inner peripheral surface of which a magnet is mounted; a pulling magnet provided to a lower portion of the rotor, for generating attractive force pulling the rotor to the lower portion; a stator including a metal bearing positioned on a lower portion of the rotor and mounted on an outer peripheral surface of the pivot, a holder provided to an outer peripheral surface of the metal bearing, and a core wired by a coil arranged, facing the magnet of the rotor with an air gap intervened, in which a housing for receiving the pulling magnet is formed on an upper end of the stator; and a turntable including a disk chuck fixed on an upper surface of the rotor, for centering and settling a disk, and a jaw installed on the disk chuck, for fixing a disk lest a disk settled down on the disk chuck should be detached.

The foregoing and other objects and advantages are realized also by providing a spindle motor used in a disk player according to the present invention, including: a deck plate; a pivot mounted on the deck plate, for being rotatable; a rotor of a cap shape, joined to an outer peripheral surface of an upper side of the pivot and having tracks formed in different heights on an upper portion, and on an inner peripheral surface of which a magnet is mounted; a pulling magnet provided to a lower portion of the rotor, for generating attractive force pulling the rotor to the lower portion; a stator including a metal bearing positioned on a lower portion of the rotor and mounted on an outer peripheral surface of the pivot, a holder provided to an outer peripheral surface of the metal bearing, and a core wired by a coil arranged, facing the magnet of the rotor with an air gap intervened, in which a housing for receiving the pulling magnet is formed on an upper end of the stator; and a turntable including a disk chuck fixed on an upper surface of the rotor, for centering and settling a disk, a jaw installed on the disk chuck, for fixing a settled disk, and a disk sheet for supporting the settled disk at an lower portion of the turntable.

### BRIEF DESCRIPTION OF THE DRAWINGS

The above objects, features and advantages of the present invention will become more apparent from the following detailed description when taken in conjunction with the accompanying drawings, in which:

FIG. 1 is a sided, cross-sectional view of construction of a general spindle motor for driving a disk;

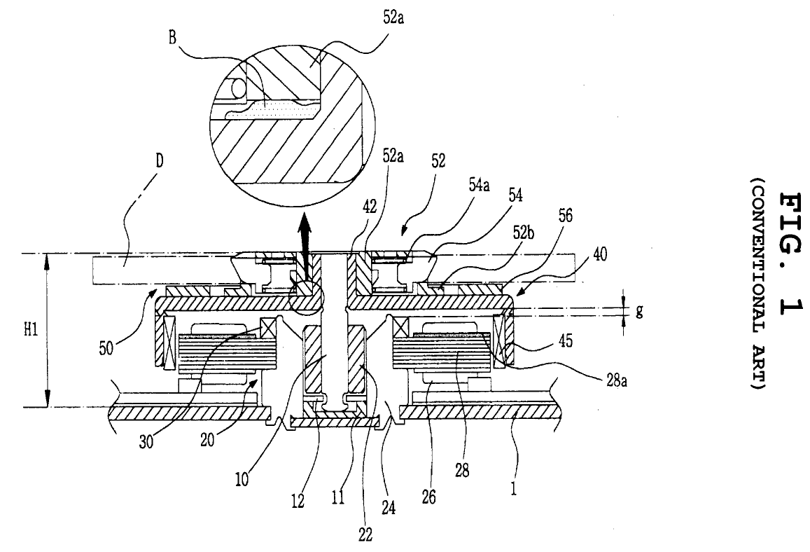

FIG. 2 is a sided, cross-sectional view of a spindle motor for driving a disk according to the first embodiment of the present invention;

FIG. 3 is a perspective view of a rotor adopted to a spindle motor for driving a disk according to the second embodiment of the present invention;

FIG. 4 is a sided, cross-sectional view of a spindle motor for driving a disk according to the second embodiment of the present invention;

FIG. 5 is a sided, cross-sectional view of a spindle motor for driving a disk according to the third embodiment of the present invention;

FIG. 6 is a sided, cross-sectional view of a spindle motor for driving a disk according to the fourth embodiment of the present invention;

FIG. 7 is a sided, cross-sectional view of a spindle motor for driving a disk according to the fifth embodiment of the present invention; and

FIG. 8 is a sided, cross-sectional view of a spindle motor for driving a disk according to the sixth embodiment of the present invention;

### DETAILED DESCRIPTION OF THE PREFERRED EMBODIMENT

A preferred embodiment of a spindle motor for driving a disk according to the present invention will be described hereinafter with reference to the accompanying drawings. In the following description, same drawing reference numerals are used for the same elements as is in the related art.

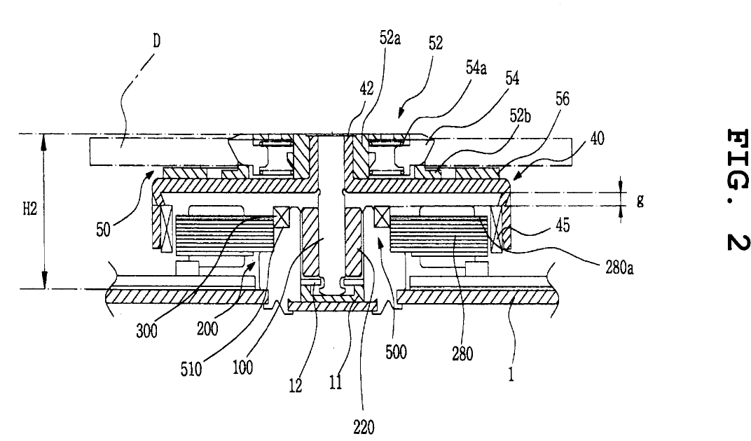

FIG. 2 is a sided, cross-sectional view of a spindle motor for driving a disk according to the first embodiment of the present invention. The spindle motor for driving a disk of the present invention includes: a deck plate 1, on the upper side of which a printed circuit board is mounted, for being fixed on a disk player not shown; a pivot 10 vertically mounted on the deck plate 1, for being rotatable, and to the lower side of which a thrust bearing 11 for preventing friction with the deck plate 1 is provided, and to the lower end of which a stopper ring 12 of a washer shape whose one side is fixed in the thrust bearing 11, is joined.

Of course, the stopper ring 12 plays a role of keeping the lower end of the pivot 100 to prevent the pivot 100 from rising to the above due to centrifugal force upon high speed rotation of the pivot 100.

Also, the present invention includes a metal rotor 40 of a cap shape such that a boss 42 of a cylindrical shape is formed on its center and the upper end of the pivot 100 is fixed to the inner peripheral surface of the boss 42 in a forcibly fitting manner, and a magnet 45 is mounted on its inner peripheral surface.

Additionally, a stator 200 for generating magnetic force interacting with the magnet 45 of the rotor 40 is provided to the lower portion of the rotor 40, and the rotor 40 is rotated by magnetic force generated from the stator 200.

More specifically, the stator 200 is mounted on the lower end of the pivot 100, for being positioned in the lower portion of the rotor 40, and the stator 200 includes: a metal bearing 220 of a cylindrical shape mounted on the lower outer peripheral surface of the pivot 100 for supporting the pivot 100 so that the pivot 100 is vertically erected; a holder 240 of a cylindrical shape mounted on the outer peripheral surface of the metal bearing 220; and a core 280 wired by a coil 260 fixed on the outer peripheral surface of the holder 240, for generating magnetic force by power source applied.

At the moment, a coating layer 280a for protecting the coil 260 and the core 280 is plastered on the surface of the core 280, and the core 280 is arranged, facing the magnet 45 with an air gap intervened so that interaction with the magnet 45 of the rotor 40 is performed smoothly.

In the meantime, a housing 500 consisting of a cut groove 510 partially cut is formed on the upper end of the holder 240, and the present invention includes a pulling magnet 300 inserted in such housing 500, for attracting the metal rotor 40 at the lower portion.

More specifically, the cut groove 510 forming the housing 500 is formed more deeply than the upper end of the core 280 formed on the outer peripheral surface of the holder 240 so that supporting area for the pulling magnet 300 is extended upon mounting of the pulling magnet 300.

Namely, as shown in FIG. 2, the lower side of the pulling magnet 300 is supported by the holder 240 due to the cut groove 510 formed more deeply than the upper end of the inner peripheral surface of the core 280, and both sides of the pulling magnet 300 are supported by the holder 240 and the core 280.

Finally, the present invention includes: a turntable 50 integrally fixed with the rotor 40 on the upper side of the rotor 40, for settling down a disk (D).

Such turntable 50 performs centering so that a disk (D) may be settled down on the exact position in the turntable, and consists of: a disk chuck 52 to which a hub 52a having a cavity in its center is provided; a jaw 54 for moving a disk (D) on the disk chuck 52 in a sliding manner, and fixing a disk (D) settled on the disk chuck 52; and a disk sheet 56 for supporting the settled disk (D) at the lower side.

Of course, the jaw 54 is inserted into the interior of the lateral side of the disk chuck 52 together with a spring 54a, and the disk sheet 56 is extended from the lower portion of the disk chuck 52, forming one body together with the disk chuck 52.

Namely, the disk sheet 56 is formed on the lower portion of the disk chuck 52 in form of an outward flange, and depending on cases, the disk sheet 56 may be formed in a separate washer shape isolated from the disk chuck 52.

As described in the foregoing, the spindle motor for driving a disk according to the first embodiment of the present invention could minimize the height of the stator 200 by receiving the pulling magnet 300 in the housing 500 of the holder 240, not attaching the pulling magnet 300 to the upper side of the core 280.

Additionally, as the pulling magnet 300 is received in the holder 240, the vertical height of the holder 240 could be reduced as shown in FIG. 2, and as the vertical height of the holder 240 is reduced, the vertical heights of the metal bearing 220 and the pivot 100 could be reduced, so that the height of the stator 200 is possibly minimized even more.

Also, the pulling magnet 300 is supported by the lower side and both sides of the holder 240, so that the pulling magnet 300 is firmly fixed to the stator 200 and detachment of the pulling magnet from the stator 200 is prevented.

Additionally, the present invention could remarkably reduce the whole height H2 of the spindle motor compared to the related art, by minimizing the height of the stator 200 while maintaining the same gap (g) formed below the rotor 40 as is the case in the related art.

Of course, the present invention could minimize the height of the disk player not shown by reducing the whole height H2 of the spindle motor, so that slim sized disk player is possibly manufactured.

Finally, as the pulling magnet 300 is mounted on the upper side of the holder 240, the coating layer 280a of the core 280 needs not to be chopped off, so that manufacturing process could be shortened and phenomenon that the pulling magnet 300 is floated above due to the coating layer 280a is prevented, for the pulling magnet 300 is not settled down on the coating layer 280a.

The spindle motor for driving a disk having the foregoing construction according to the first embodiment of the present invention, is operated as follows, in which: the disk chuck 52 of the turntable 50 performs centering for a through hole formed on the center of a disk (D), fixing the same, and the jaw 54 is slid into the interior of the lateral side of the disk chuck 52 through the through hole formed on a disk (D) upon fixing, and then when centering is completed, the jaw 54 is again projected, in a sliding manner, into the exterior of the disk chuck 52 by elastic force of the spring 54a, fixing a disk (D) by pushing and pressing the inside of the through hole of a disk (D).

If fixing of a disk (D) is completed, power source is applied to the coil 260 of the stator 200, so that magnetic force is generated to the core 280, and magnetic force of the core 280 interacts with magnetic force of the magnet 45 mounted on the rotor 40.

Then, the core 280 and the magnet 45 rotate the pivot 100 together with the rotor 40 by interaction of magnetic forces generated.

At the moment, the pivot 100 could smoothly rotate in high speed at vertical status without vibration thanks to the metal bearing 220 mounted on the outer peripheral surface, and does not rise to the above upon high speed rotation thanks to the stopper ring 12 mounted on the lower end of the pivot 100.

In the meantime, the rotor 40 rotating in high speed together with the pivot 100 would also rise due to centrifugal force generated upon high speed rotation, but rising of the rotor 40 is prevented by attractive force of the pulling magnet 300.

Additionally, due to rotation of the rotor 40, the turntable 50 mounted on the upper side of the rotor 40 is rotated, and a disk (D) settled on the turntable 50 is also rotated in high speed together with the turntable 50, so that the disk player not shown could record data on a disk (D) or play recorded data from a disk (D) in a short period of time.

Of course, a disk (D) does not rise or is not detached from the turntable 50 even though rotated in high speed as the jaw 54 of the turntable 50 strongly fixes a disk (D), and further, a disk (D) does not rise or is not detached thanks to a disk clamp not shown, for pushing a disk (D) at the upper side.

In the meantime, the whole height of the spindle motor could be reduced even more by changing the structure of the rotor 40 mounted on the upper portion of the stator 200, which will be described in the following.

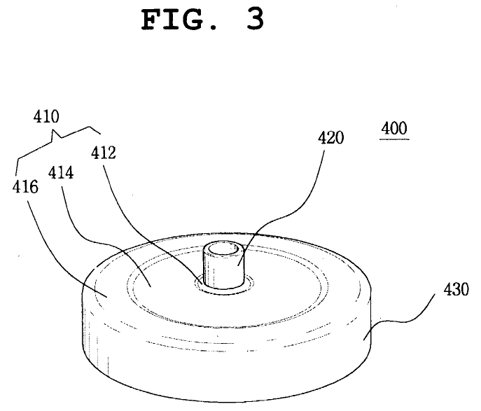

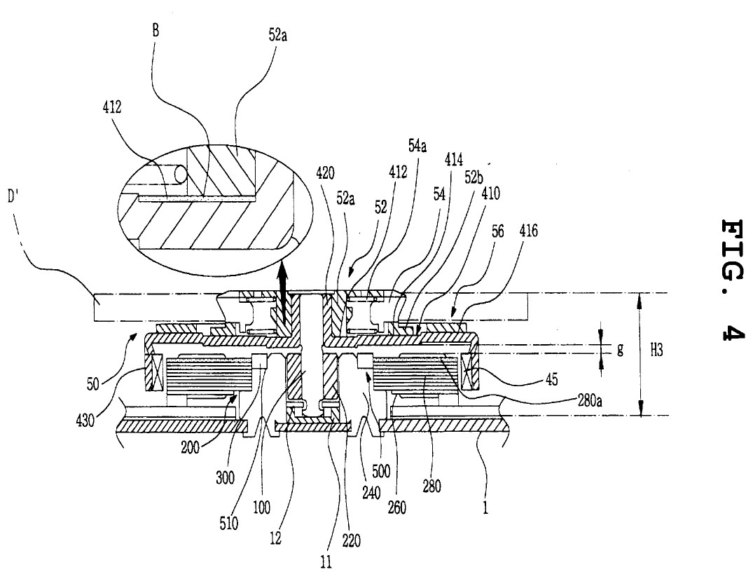

FIG. 3 is a perspective view of a rotor adopted to a spindle motor for driving a disk according to the second embodiment of the present invention, and FIG. 4 is a sided, cross-sectional view of a spindle motor for driving a disk according to the second embodiment of the present invention. In the following description, the same reference numerals are used for the same elements as is in the first embodiment of the present invention described in the above, and descriptions of the constructions and operations already made in the first embodiment are omitted.

Referring to FIG. 3 and FIG. 4, the construction of the spindle motor for driving a disk according to the second embodiment of the present invention including a pivot 100, a stator 200 mounted on the lower end of the pivot 100, a pulling magnet received in a housing 500 of the stator 200, and a turntable 50 for settling down a disk (D), is the same as that of the spindle motor according to the first embodiment of the present invention described above, with only difference in the structure of the rotor 400 having a magnet 45 in its inner peripheral surface.

More specifically, such rotor 400 includes a boss 420 pushed and fixed on the inner peripheral surface of the pivot 100 in a forcibly fitting manner, a track 410 horizontally extended from the boss 420 and formed in different heights, and a cylinder 430 extended downward from the track 410. Here, the pivot 100 is pushed and fixed in the boss 420, so that the pivot 100 and the rotor 400 are integrally joined as one body.

The track 410 of the rotor 400 has a plurality of horizontal portions 412, 414, and 416 having stepped difference by drawing process, and the horizontal portions 412, 414, and 416 are of upward stepped structure such that the horizontal portions are gradually getting higher to the exterior direction from the pivot 100 inserted into the boss 420, i.e., to the direction of a cylinder 430, which is the outer side of the track 410.

At the moment, the horizontal portions 412, 414, and 416 consist of the first horizontal portion 412 formed close to the pivot 100 and having lowest height, the second horizontal portion 414 formed at the outer side of the first horizontal portion 412 and formed higher than the first horizontal portion 412 by stepped difference, and the third horizontal portion 416 formed at the outer side of the second horizontal portion 414 and formed higher than the second horizontal portion 414 by stepped difference.

Namely, the first horizontal portion 412 is formed adjacent to the pivot 100, and the third horizontal portion 416 is formed adjacent to the side of the cylinder 430, and the second horizontal portion 414 is formed between the first horizontal portion 412 and the third horizontal portion 416.

On such first, second, and third horizontal portions 412, 414, and 416, the lower end of a hub 52a, a lower side 52b of the disk chuck 52, and a disk sheet 56 of the turntable 50 are sequentially settled down, respectively.

Of course, in order for such elements of the turntable 50 to be settled down on the first, the second, and the third horizontal portions 412, 414, 416, the lower portion of the turntable 50 should be formed to correspond to the horizontal portions 412, 414, 416.

In other words, as shown in FIG. 4, the thickness of the lower side 52b of the disk chuck 52 should be formed thin, so that the lower end of the hub 52a is relatively projected in response to the dept of the first horizontal portion 412, and the disk sheet 56 should be formed in the higher position than the lower side 52b so that the disk sheet 56 may be correspond to the height of the third horizontal portion 416.

Of course, the disk sheet 56 may be formed in a separate washer shape isolated from the disk chuck 52, and in that case, the disk sheet 56 could be attached to the third horizontal portion 416 regardless of the lower portion structure of the turntable 50.

In the meantime, before the hub 52a is settled down, the adhesive (B) is plastered on the upper side of the first horizontal portion 412 on which the hub 52a of the disk chuck 52 is settled down, so that the hub 52a is bonded and fixed on the first horizontal portion 412.

Namely, the turntable 50 is firmly fixed in the rotor 400 as one body by the adhesive (B) plastered on the lower side of the hub 52a and the pivot 10 pushed and fixed in the inner periphery of the hub 52a.

But, unlike the foregoing, though not shown in the drawing, the depth of the first horizontal portion 412 may be formed as much as the thickness of the adhesive (B), and in that case, the lower end of the hub 52a should not be projected.

More specifically, the first horizontal portion 412 is processed so that a fine depth is formed on it, and the adhesive (B) is filled as much as the processed depth, and then the hub 52a is positioned on the adhesive (B). When the adhesive (B) is hardened at that status, the hub 52a is bonded to and fixed in the first horizontal portion 412 by the portion facing the adhesive (B).

According to the second embodiment of the present invention having the foregoing construction, the turntable 50 is bonded to the rotor 400, so that the turntable is more firmly fixed in the rotor and the adhesive (B) is not gathered in one place, for the adhesive (B) is uniformly plastered on the upper side of the first horizontal portion 412.

Therefore, the turntable 50 is not floated by the adhesive (B) and resultantly, the whole height H3 of the spindle motor is reduced, and the adhesive (B) is bonded on the whole area of the lower side of the hub 52a, so that the wide bonding area for the turntable 50 and the rotor 400 is secured and adhesive force of the turntable 50 is increased.

Also, the lower side 52b of the disk chuck 52 is settled down on the second horizontal portion 414 of the rotor 400, so that the turntable 50 is settled down in a subsiding manner as much as the depth of the second horizontal portion 414 and the whole height H3 of the spindle motor could be reduced even more.

Of course, as being formed in a stepped structure, the rotor 400 and the stator 200 could maintain a constant gap (g) between them, reducing the whole height H3 of the spindle motor.

Resultantly, the spindle motor according to the second embodiment of the present invention could minimize the whole height H3, also reducing the height of the disk player adopting such spindle motor, thereby possibly manufacturing the slim type disk player of compact sized.

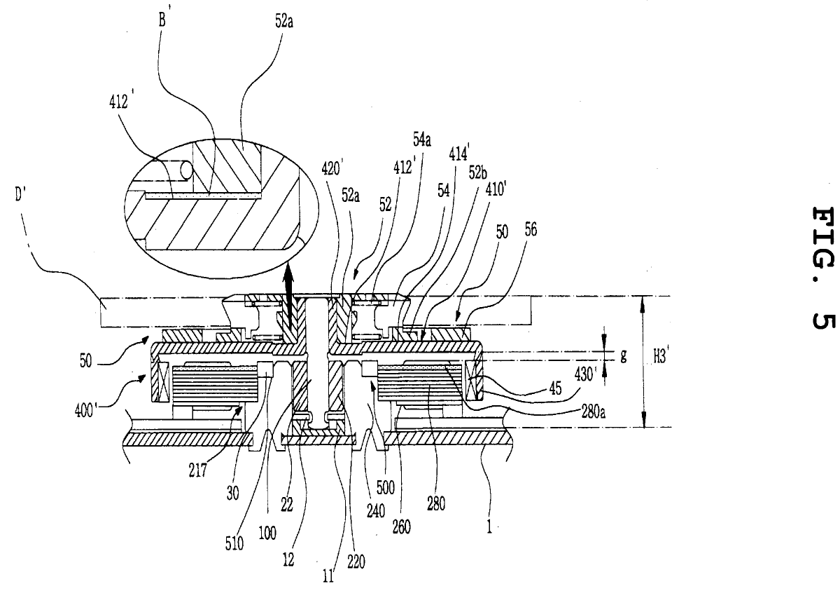

In the meantime, the track 410 of the rotor 400 could be formed by two horizontal portions. FIG. 5 is a sided, cross-sectional view of a spindle motor for driving a disk according to the third embodiment of the present invention adopting such rotor 400′. In the description, the same reference numerals are used for the same elements as is in the second embodiment of the present invention described in the above, and descriptions of the constructions and operations already made in the second embodiment are omitted.

Referring to FIG. 5, the construction of the spindle motor for driving a disk according to the third embodiment of the present invention including a pivot 100, a stator 200 mounted on the lower end of the pivot 100, a pulling magnet received in a housing 500 of the stator 200, and a turntable 50 for settling down a disk (D), is the same as that of the spindle motor according to the second embodiment of the present invention described above, with only difference in the track 410′ of the rotor 400′ having a magnet 45 in its inner peripheral surface.

The track 410′ of the rotor 400′ has two horizontal portions 412′, 414′ having stepped difference by drawing process, and the horizontal portions 412, 414 are of upward stepped structure such that the horizontal portions are gradually getting higher in the exterior direction from the pivot 100 inserted into the boss 420′, i.e., in the direction of a cylinder 430′, which is the outer side of the track 410′.

At the moment, the horizontal portions 412′, 414′ consist of the first horizontal portion 412′ formed close to the pivot 100 and having lowest height, and the second horizontal portion 414′ formed at the outer side of the first horizontal portion 412′ and formed higher than the first horizontal portion 412′ by stepped difference.

Namely, the first horizontal portion 412′ is formed adjacent to the pivot 100, and the second horizontal portion 414′ is extended from the first horizontal portion 412′.

On such first and second horizontal portions 412′, 414′ the lower end of a hub 52a, a lower side 52b of the disk chuck 52, and a disk sheet 56 of the turntable 50 are settled down, respectively.

Of course, in order for elements of the turntable 50 to be settled down on the first and the second horizontal portions 412′, 414′, the lower portion of the turntable 50 should be formed to correspond to the horizontal portions 412′, 414′.

In other words, as shown in FIG. 5, the hub 52a of the disk chuck 52 should be projected downward in response to the dept of the first horizontal portion 412′, and the lower side 52a of the disk chuck 52 and disk sheet 56 should be formed in the higher position than the lower side of the hub 52a to correspond to the height of the second horizontal portion 414′.

Namely, the lower side 52b of the disk chuck 52 and the disk sheet 56 consist of an outward flange structure extended from the lower portion of the disk chuck 52, and the hub 52a is formed in a shape projected to the lower portion of the outward flange.

Of course, the disk sheet 56 may be formed in a separate washer shape isolated from the disk chuck 52, and in that case, the disk sheet 56 could be attached to the second horizontal portion 414′ regardless of the lower portion structure of the turntable 50.

In the meantime, before the hub 52a is settled down, the adhesive (B) is plastered on the upper side of the first horizontal portion 412′ on which the hub 52a of the disk chuck 52 is settled down, so that the hub 52a is bonded and fixed on the first horizontal portion 412′.

But, unlike the foregoing, though not shown in the drawing, the depth of the first horizontal portion 412′ may be formed as much as the thickness of the adhesive (B), and in that case, the lower end of the hub 52a should not be projected.

More specifically, the first horizontal portion 412′ is processed so that a fine depth is formed on it, and the adhesive (B′) is filled as much as the processed depth, and then the hub 52a is positioned on the adhesive (B′). When the adhesive (B′) is hardened at that status, the hub 52a is bonded to and fixed in the first horizontal portion 412′ by the portion facing the adhesive (B′).

According to the third embodiment of the present invention having the foregoing construction, the turntable 50 is not only fixed firmly in the rotor 400′, but also the adhesive (B′) is not gathered in one place, for the adhesive (B′) is uniformly plastered on the upper side of the first horizontal portion 412′.

Therefore, the turntable 50 is not floated by the adhesive (B′) and resultantly, the whole height H3′ of the spindle motor is reduced, and the adhesive (B′) is bonded on the whole area of the lower side of the hub 52a, so that the wide bonding area for the turntable 50 and the rotor 400′ is secured and adhesive force of the turntable 50 is increased.

Of course, as being formed in a stepped structure, the rotor 400′ and the stator 200′ could maintain a constant gap (g) between them, reducing the whole height H3′ of the spindle motor.

Resultantly, the spindle motor according to the third embodiment of the present invention could minimize the whole height H3′, also reducing the height of the disk player adopting such spindle motor, thereby possibly manufacturing the slim type disk player of compact sized.

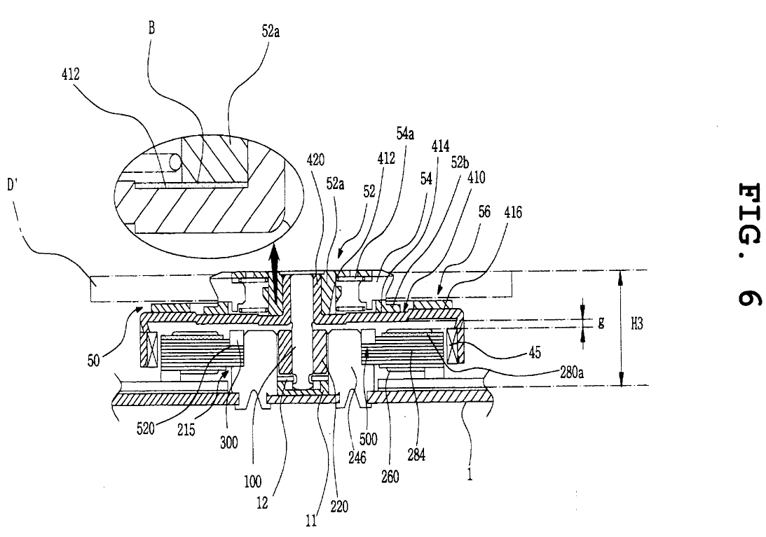

In the meantime, FIG. 6 is a sided, cross-sectional view of a spindle motor for driving a disk according to the fourth embodiment of the present invention. The construction of the spindle motor for driving a disk according to the fourth embodiment of the present invention, is the same as that of the spindle motor according to the second embodiment of the present invention as shown in FIG. 4, with only difference in the structures of the holder 246 and the core 284 of the stator 215.

Therefore, in the descriptions, the same reference numerals are used for the same elements as is in the second embodiment of the present invention, and descriptions of the constructions and operations already made in the second embodiment are omitted.

Referring to FIG. 6, a housing 500 having a cut groove 520 partially cut is formed on the upper end of the core 284, and a pulling magnet 300 is received in the inside of the housing 500, so that the height of the pulling magnet 300 projected to the upper side of the core 284 could be reduced.

At the moment, the vertical height of the holder 246 could be reduced as much as the height of the pulling magnet 300 whose height is reduced and the vertical heights of the metal bearing 220 and the pivot 100 could be also reduced, so that the whole height H3 of the spindle motor could be reduced with the gap (g) maintained between the stator 215 and the lower side of the rotor 400 as are the cases in the first embodiment through the third embodiment of the present invention.

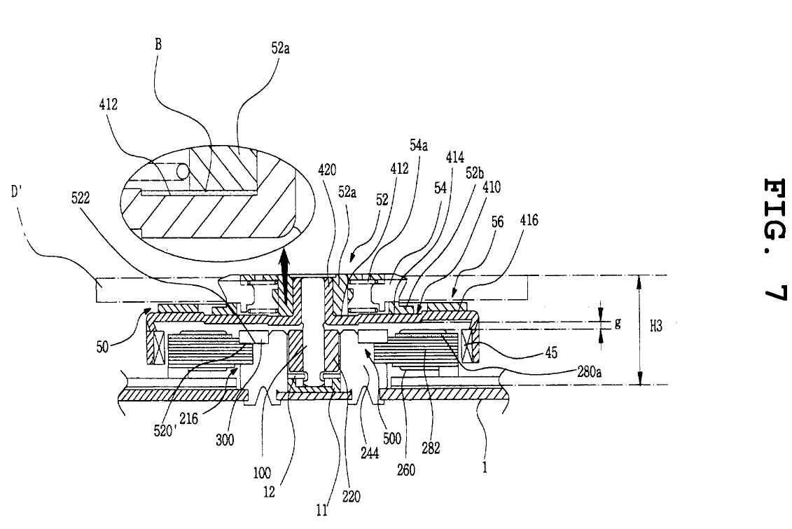

Of course, the housing 500 may be structured as shown in FIG. 7. FIG. 7 is a sided, cross-sectional view of a spindle motor for driving a disk according to the fifth embodiment of the present invention. The construction of the spindle motor for driving a disk according to the fifth embodiment of the present invention, is the same as those of the spindle motor according to the first embodiment through the fourth embodiment of the present invention, with only difference in formation of a housing 500 positioned on the upper end of a holder 244 and a core 282

Namely, a cut groove 520′ is formed on the upper end of the core 282 in the stator 216, and another cut groove 522 for corresponding to the cut groove 520′ of the core 282 is formed on the upper end of the holder 244 so that the housing 500 for receiving the pulling magnet 300 is formed.

The pulling magnet 300 is mounted in the inside of the upper end of the stator 216 in a subsiding manner, not projected to the upper portion of the stator 216, so that the whole height H3 of the spindle motor could be reduced with the gap (g) maintained between the stator 216 and the lower side of the rotor 400.

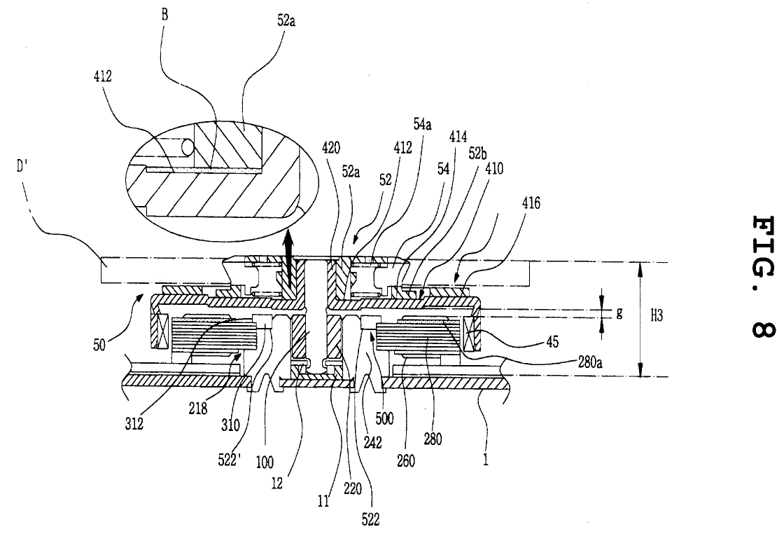

In the meantime, FIG. 8 is a sided, cross-sectional view of a spindle motor for driving a disk according to the sixth embodiment of the present invention. The construction of the spindle motor for driving a disk according to the sixth embodiment of the present invention, is the same as those of the spindle motor according to the foregoing embodiments of the present invention, with only difference in formation of a housing having a cut groove 522′ on the upper end of the holder 242 and in a structure of a pulling magnet 310.

More specifically, the pulling magnet 310 whose structure is changed, has an outward flange 312 on its upper end so that its volume is increased as shown in FIG. 8.

At the moment, the pulling magnet 310 is inserted into the cut groove 522′ of the housing 500 as are the cases of the foregoing embodiments, and the lower side of the outward flange 312 is settled down on the upper side of the core 280.

Therefore, the pulling magnet 310 is possibly mounted in the inside of the stator 218 in a subsiding manner and the whole height of the spindle motor could be reduced with the gap (g) maintained between the stator 218 and the rotor 400, and additionally, the volume of the pulling magnet 310 could be enlarged and magnetic force is strengthened, whereby attractive force pulling the rotor 400 could also be increased.

The spindle motor for driving a disk according to the first embodiment through the sixth embodiment of the present invention as described in the foregoing, could reduce the vertical heights of elements including pivot 100 constituting the stator 200, 215, 216, 218 by mounting the pulling magnet 300, 310 in the inside of the upper end of the stator 200, 215, 216, 218 in a subsiding manner, thereby reducing the whole height H2, H3 of the spindle motor.

Also, the spindle motor of the present invention could mount the turntable 50 on the rotor 400, 400′ in a subsiding manner by applying the rotor 400, 400′ having cross section of a stepped structure, thereby reducing the whole height H3, H3′ the spindle motor even more.

Therefore, the height of the disk player not shown could also be reduced as much as the reduced height of the spindle motor, whereby the slim type disk player could be manufactured.

Additionally, the turntable 50 is bonded after the adhesive is plastered on the upper side of the rotor 400, 400′, so that the bonding area for the turntable 50 is extended and the bonding force is strengthened. Also, the pulling magnet 310 has the outward flange 312, so that strengthened magnetic force is generated due to volume increase.

The foregoing embodiments and advantages are merely exemplary and are not to be construed as limiting the present invention. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

While the invention has been shown and described with reference to certain preferred embodiments thereof, it will be understood by those skilled in the art that various changes in form and details may be made therein without departing from the spirit and scope of the invention as defined by the appended claims.

The spindle motor for driving a disk having the foregoing construction and operation according to the present invention, has effects of reducing the vertical height of elements constituting the stator, by mounting the pulling magnet in the inside of the upper end of the stator in a subsiding manner, thereby reducing the whole height of the spindle motor, for the rotor is mounted downward as much as the reduced height of the pulling magnet.

Also, due to the rotor consisting of the track having depth, the turntable could be mounted downward as much as the depth of the track, so that the whole height of the spindle motor could be reduced even more. Resultantly, the height of the disk player adopting such spindle motor could be reduced, so that the slim type disk player could be manufactured.

Also, after the adhesive is plastered on the upper side of the track having depth, the turntable is mounted, so that the boding area for the turntable is extended and the turntable is firmly bonded to the rotor. Additionally, the pulling magnet has the outward flange on its upper end, so that its volume is increased and generated magnetic filed is strengthened accordingly.

What is claimed is:

1. A spindle motor used in a disk player, comprising:
a deck plate;
a pivot mounted on the deck plate, for being rotatable;
a rotor of a cap shape, joined to an outer peripheral surface of an upper side of the pivot and on an inner peripheral surface of which a magnet is mounted;
a pulling magnet provided to a lower portion of the rotor, for generating attractive force pulling the rotor to the lower portion;
a stator including a metal bearing positioned on a lower portion of the rotor and mounted on an outer peripheral surface of the pivot, a holder provided to an outer peripheral surface of the metal bearing, and a core wired by a coil arranged, facing the magnet of the rotor with an air gap intervened, in which a housing for receiving the pulling magnet is formed on an upper end of the stator; and
a turntable including a disk chuck fixed on an upper surface of the rotor, for centering and settling down a disk, and a jaw installed on the disk chuck, for fixing a disk lest a disk settled down on the disk chuck should be detached.

2. The spindle motor according to claim 1, wherein the housing comprises a cut groove configured such that a part of an upper end of the holder is cut.

3. The spindle motor according to claim 2, wherein the cut groove is formed deeper than an upper end of the core.

4. The spindle motor according to claim 3, wherein the pulling magnet has an outward flange at its upper end and the outward flange is settled down on an upper side of the core.

5. The spindle motor according to claim 1, wherein the housing comprises a cut groove configured such that a part of an upper end of the core is cut.

6. The spindle motor according to claim 1, wherein the housing comprises a cut groove configured such that parts of upper ends of the holder and the core are cut.

7. A spindle motor used in a disk player, comprising:
a deck plate;
a pivot mounted on the deck plate, for being rotatable;
a rotor of a cap shape, joined to an outer peripheral surface of an upper side of the pivot and having tracks formed in different heights on an upper portion, and on an inner peripheral surface of which a magnet is mounted;
a pulling magnet provided to a lower portion of the rotor, for generating attractive force pulling the rotor to the lower portion;
a stator including a metal bearing positioned on a lower portion of the rotor and mounted on an outer peripheral surface of the pivot, a holder provided to an outer peripheral surface of the metal bearing, and a core wired by a coil arranged, facing the magnet of the rotor with an air gap intervened, in which a housing for receiving the pulling magnet is formed on an upper end of the stator; and
a turntable including a disk chuck fixed on an upper surface of the rotor, for centering and settling a disk, a jaw installed on the disk chuck, for fixing a disk lest a disk settled down on the disk chuck should be detached, and a disk sheet for supporting the settled disk at a lower portion of the turntable.

8. The spindle motor according to claim 7, wherein the track comprises a plurality of horizontal portions formed by stepped difference.

9. The spindle motor according to claim 8, wherein the horizontal portion has an upward stepped structure such that a height in an outer direction gets gradually higher than a height of the pivot joined to a center of the rotor.

10. The spindle motor according to claim 9, wherein the horizontal portion comprises two parts.

11. The spindle motor according to claim 10, wherein the horizontal portion comprises a first horizontal portion on which a lower end of a center of the disk chuck is bonded and fixed, and a second horizontal portion on which a lower side of the disk chuck and the disk sheet are settled down.

12. The spindle motor according to claim 9, wherein the horizontal portion comprises three parts.

13. The spindle motor according to claim 12, wherein the horizontal portion comprises a first horizontal portion on which a lower end of a center of the disk chuck is bonded and fixed, a second horizontal portion on which a lower side of the disk chuck is settled down and a third horizontal portion on which the disk sheet is settled down.

14. The spindle motor in any of claim 7 through claim 13, wherein the housing comprises a cut groove configured such that a part of an upper end of the holder is cut.

15. The spindle motor according to claim 14, wherein the cut groove is formed deeper than an upper end of the core.

16. The spindle motor according to claim 15, wherein the pulling magnet has an outward flange at its upper end and the outward flange is settled down on an upper side of the core.

17. The spindle motor in any of claim 7 through claim 13, wherein the housing comprises a cut groove configured such that a part of an upper end of the core is cut.

18. The spindle motor in any of claim 7 through claim 13, wherein the housing comprises a cut groove configured such that parts of upper ends of the holder and the core are cut.
